(19) United States
(12) Patent Application Publication
(10) Pub. No.: US 2026/0146349 A1
(43) Pub. Date: May 28, 2026

(54) WATER ELECTROLYSIS SYSTEM AND CONTROL METHOD THEREFOR

(71) Applicant: HONDA MOTOR CO., LTD., TOKYO (JP)

(72) Inventor: Keizo IWAMA, WAKO-SHI (JP)

(21) Appl. No.: 19/400,260

(22) Filed: Nov. 25, 2025

(30) Foreign Application Priority Data
Nov. 28, 2024 (JP) 2024-207372

(51) Int. Cl. C25B 15/02; C25B 1/04; C25B 9/23; C25B 9/65; C25B 15/08

(52) U.S. Cl. CPC C25B 15/02; C25B 1/04; C25B 9/23; C25B 9/65; C25B 15/08

(57) ABSTRACT

A control device, when a water electrolysis system is initiated, controls electrical power source devices in a manner so that a water electrolysis electrical current and a hydrogen compression electrical current increase gradually in coordination. During such gradual increasing, it is detected whether or not flooding has occurred in a hydrogen compression stack, and at a time when it is detected that flooding is occurring, until the flooding is eliminated, a flooding elimination control is carried out in which an increase in the water electrolysis electrical current and the hydrogen compression electrical current is temporarily suspended and the water electrolysis electrical current and the hydrogen compression current are maintained at a constant current value in coordination.

### CROSS-REFERENCE TO RELATED APPLICATIONS

This application is based upon and claims the benefit of priority from Japanese Patent Application No. 2024-207372 filed on Nov. 28, 2024, the contents of which are incorporated herein by reference.

### BACKGROUND OF THE INVENTION

### Field of the Invention

The present invention relates to a water electrolysis system and a control method therefor.

### Description of the Related Art

In recent years, in order to make it possible for more people to be capable of relying thereon at an affordable cost, and to ensure access to sustainable and advanced energy, research and development have been conducted in relation to a fuel cell that contributes to energy efficiency.

In JP 7421581 B2, a water electrolysis system is disclosed having a water electrolysis stack and a hydrogen compression stack.

### SUMMARY OF THE INVENTION

In the hydrogen compression stack of such a water electrolysis system, there may be cases in which condensed water (dew condensation water) is generated in the interior of the hydrogen compression stack due to changes in the outside air temperature or the like during a standby state (hereinafter referred to as flooding).

When flooding exists in a hydrogen compression stack, a cell resistance value of the hydrogen compression stack increases. Due to the increase in the cell resistance value, the cell voltage of the hydrogen compression stack rises in proportion to an increase in a supply current to the hydrogen compression stack at the time when the water electrolysis system is initiated. There is a problem in that the hydrogen compression stack may break down if the cell voltage that has risen exceeds a membrane protective voltage.

The present invention has the object of solving the aforementioned problem.

An aspect of the present disclosure is characterized by a water electrolysis system, comprising a water electrolysis stack comprising a water electrolysis membrane electrode assembly in which an electrolyte membrane is sandwiched between an anode and a cathode, and configured to generate hydrogen gas and oxygen gas from water that is supplied thereto, a water electrolysis electrical power source device configured to supply a water electrolysis electrical current between the anode and the cathode of the water electrolysis membrane electrode assembly, a hydrogen compression stack comprising a hydrogen compression membrane electrode assembly in which an electrolyte membrane is sandwiched between an anode and a cathode, and configured to compress the hydrogen gas that is generated by the water electrolysis stack, a hydrogen compression electrical power source device configured to supply a hydrogen compression electrical current between the anode and the cathode of the hydrogen compression membrane electrode assembly, and a control device configured to control the water electrolysis electrical power source device and the hydrogen compression electrical power source device, wherein the control device controls, at a time when the water electrolysis system is initiated, the water electrolysis electrical power source device and the hydrogen compression electrical power source device in a manner so that the water electrolysis electrical current and the hydrogen compression electrical current gradually increase, detects, while the water electrolysis electrical current and the hydrogen compression electrical current are gradually increasing, whether or not flooding is occurring in the hydrogen compression stack, and carries out, at a time when it is detected that flooding is occurring, a control to cause the increasing of the water electrolysis electrical current and the hydrogen compression electrical current to be suspended and to maintain the water electrolysis electrical current and the hydrogen compression electrical current at a constant electrical current value.

Another aspect of the present disclosure is characterized by a method of controlling a water electrolysis system, comprising a water electrolysis stack comprising a water electrolysis membrane electrode assembly in which an electrolyte membrane is sandwiched between an anode and a cathode, and configured to generate hydrogen gas and oxygen gas from water that is supplied thereto, a water electrolysis electrical power source device configured to supply a water electrolysis electrical current between the anode and the cathode of the water electrolysis membrane electrode assembly, a hydrogen compression stack comprising a hydrogen compression membrane electrode assembly in which an electrolyte membrane is sandwiched between an anode and a cathode, and configured to compress the hydrogen gas that is generated by the water electrolysis stack, and a hydrogen compression electrical power source device configured to supply a hydrogen compression electrical current between the anode and the cathode of the hydrogen compression membrane electrode assembly, and a control device configured to control the water electrolysis electrical power source device and the hydrogen compression electrical power source device, the method of controlling the water electrolysis system comprising a step of controlling, at a time when the water electrolysis system is initiated, the water electrolysis electrical power source device and the hydrogen compression electrical power source device in a manner so that the water electrolysis electrical current and the hydrogen compression electrical current gradually increase, a step of detecting, while the water electrolysis electrical current and the hydrogen compression electrical current are gradually increasing, whether or not flooding is occurring in the hydrogen compression stack, and a step of causing, at a time when it is detected that flooding is occurring, the increasing of the water electrolysis electrical current and the hydrogen compression electrical current to be suspended and maintaining the water electrolysis electrical current and the hydrogen compression electrical current at a constant electrical current value.

According to the present invention, at the time when the water electrolysis system is initiated, the control device controls the water electrolysis electrical power source device and the hydrogen compression electrical power source device in a manner so that the water electrolysis electrical current and the hydrogen compression electrical current gradually increase. The control device, during the gradual increasing of the water electrolysis electrical current and the hydrogen compression electrical current, detects whether or not flooding has occurred in the hydrogen compression stack. The control device, at a time when it is detected that flooding is occurring, carries out a flooding elimination control by causing the increasing of the water electrolysis electrical current and the hydrogen compression electrical current to be suspended to maintain the water electrolysis electrical current and the hydrogen compression electrical current at a constant current value until the flooding is eliminated.

In accordance with these features, even if flooding occurs in the hydrogen compression stack at the time when the water electrolysis system is initiated, the flooding can be eliminated without stopping the operation of the water electrolysis system. As a result, the water electrolysis system is capable of continuing the generation of the hydrogen gas and the oxygen gas. In accordance therewith, it is possible to prevent beforehand malfunctioning of the hydrogen compression stack.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of a regenerative fuel cell system including a water electrolysis system according to an embodiment;

FIG. 2 is an operational transition process diagram showing operating and suspended states of the regenerative fuel cell system shown in FIG. 1;

FIG. 3 is a flowchart (1/2) in which a description is provided of a pressure rising mode process according to a first exemplary embodiment;

FIG. 4 is a flowchart (2/2) in which a description is provided of the pressure rising mode process according to first to third exemplary embodiments;

FIG. 5A is a time chart showing changes over time in respective cell currents of a water electrolysis stack and a hydrogen compression stack, FIG. 5B is a time chart showing changes over time in a cell voltage of the hydrogen compression stack, and FIG. 5C is a time chart showing changes over time in a supply pressure of hydrogen that is supplied to the hydrogen compression stack;

FIG. 6 is a flowchart (1/2) in which a description is provided of the pressure rising mode process according to a second exemplary embodiment; and

FIG. 7 is a flowchart (1/2) in which a description is provided of the pressure rising mode process according to a third exemplary embodiment.

### DETAILED DESCRIPTION OF THE INVENTION

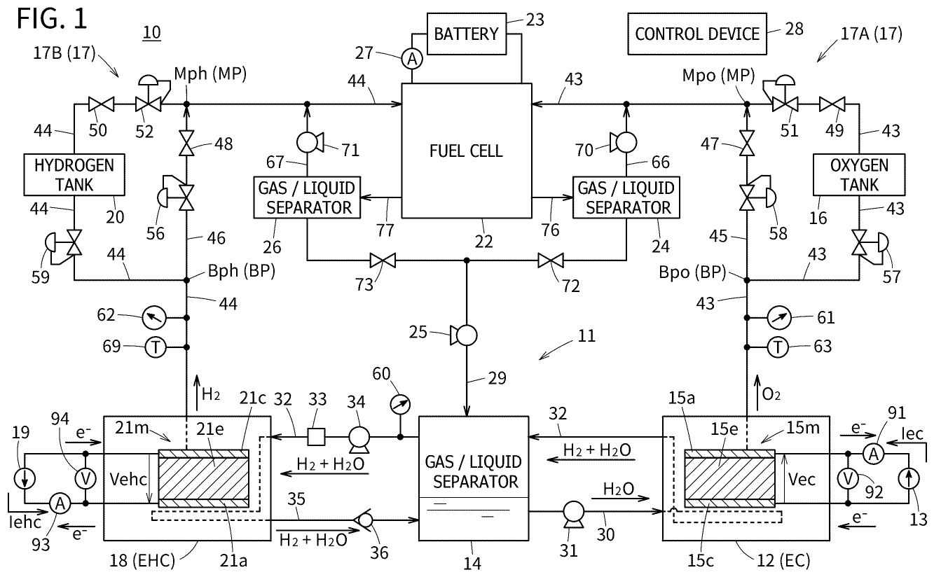

FIG. 1 is a schematic diagram of a regenerative fuel cell system (RFC) 10 that includes a water electrolysis system 11 according to an embodiment, and which implements a control method therefor.

### Overall Description of Regenerative Fuel Cell System 10

The regenerative fuel cell system 10 basically comprises the water electrolysis system 11, a fuel cell (a fuel cell stack) 22, and a control device 28. The water electrolysis system 11 is equipped with a water electrolysis stack 12, a hydrogen compression stack 18, a gas/liquid separator 14, an oxygen supplying mechanism 17A, a hydrogen supplying mechanism 17B, and the control device 28. The gas/liquid separator 14 is a hydrogen gas/liquid separator device that also functions as a hydrogen gas supplying device and a water supplying device. In the present embodiment, with respect to the fuel cell 22, the oxygen supplying mechanism 17A and the hydrogen supplying mechanism 17B are manufactured symmetrically in terms of the mechanical components thereof such as piping and the like, and the volume of portions thereof through which each of the gases flows is also the same. An oxygen tank 16 and a hydrogen tank 20, which will be described later, also use the same volume. Even if these elements are not the same, the present invention can be applied.

The control device 28 controls all of the components of the regenerative fuel cell system 10, including the water electrolysis system 11. The control device 28 may be divided into a plurality.

### Water Electrolysis Stack 12

The water electrolysis stack 12 is constituted as a high differential pressure water electrolysis stack apparatus (EC) that generates an electrochemically compressed high pressure oxygen gas and a low pressure hydrogen gas by means of water electrolysis.

Water (H₂O) for water electrolysis that is required in the water electrolysis stack 12 is supplied via a water supply path 30 from the gas/liquid separator 14 to the water electrolysis stack 12.

The water supply path 30 connects the water electrolysis stack 12 and the gas/liquid separator 14. A pump 31 is disposed in the water supply path 30. The pump 31 is an electrically powered pump that is ON/OFF controlled by the control device 28. When the pump 31 is turned ON, the pump imparts mechanical energy to the water in the gas/liquid separator 14, and supplies the water from the gas/liquid separator 14 to the water electrolysis stack 12. When the pump 31 is turned OFF, the supply of the water from the gas/liquid separator 14 to the water electrolysis stack 12 is stopped. All of the other pumps described below, similarly, are electrically powered pumps that impart mechanical energy to the fluid when turned ON, and cause the flow of the fluid to be stopped when turned OFF.

The water electrolysis stack 12 is equipped with at least one unit cell having an electrolyte membrane 15e. The unit cell includes a membrane electrode assembly (MEA) (a water electrolysis membrane electrode assembly) 15m in which the electrolyte membrane 15e is sandwiched between an anode 15a and a cathode 15c. In the present embodiment, the electrolyte membrane 15e that is used in the water electrolysis stack 12 is an anion exchange membrane.

The water electrolysis stack 12 supplies water from the gas/liquid separator 14 to the cathode 15c of each of the unit cells. Each of the unit cells electrolyzes the water based on an electrical current that is supplied to the anode 15a and the cathode 15c from an electrical power source device (a water electrolysis electrical power source device) 13. In this case, at the anode 15a, a high pressure oxygen gas (02) that is compressed (for example, in a range of 1 to 100 MPa) is generated, and uncompressed hydrogen gas (H₂) is generated at the cathode 15c.

A reaction formula on the side of the anode 15a of the water electrolysis stack 12 is shown below.

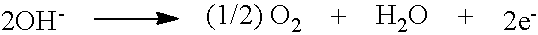

A reaction formula on the side of the cathode 15c of the water electrolysis stack 12 is shown below.

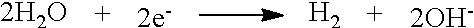

In this manner, in the water electrolysis stack 12, oxygen gas and hydrogen gas are generated in a ratio of 1:2 in terms of the amount of substance (mol) thereof.

The control device 28 is capable of variably controlling an electrical current (a water electrolysis electrical current) Iec (hereinafter referred to as an EC electrical current Iec) that is supplied from the electrical power source device 13 between the anode 15a and the cathode 15c. The electrical power source device 13 may use the electrical power of a battery 23.

The value of the EC electrical current Iec that is supplied to the anode 15a from the electrical power source device 13 is detected by an electrical current sensor 91.

The value of a cell voltage Vec, which is the voltage applied to the membrane electrode assembly 15m (the unit cell), is detected as a stack voltage by a voltage sensor 92. The control device 28 acquires the stack voltage and stores the cell voltage Vec obtained by dividing the stack voltage by the number of cells.

The water electrolysis stack 12 collects the high pressure oxygen gas that is generated in each of the unit cells, and outputs a released gas, in which the oxygen gas is contained, through an oxygen supply path 43 to the oxygen supplying mechanism 17A. Moreover, the released gas includes therein water vapor that is vaporized by the heat of the water electrolysis stack 12 or the like.

At the same time, the water electrolysis stack 12 collects the hydrogen gas that is generated in each of the unit cells, and excess water (unreacted water) that has not been subjected to electrolysis, and outputs a released fluid, in which the hydrogen gas and unreacted water are contained, to a first hydrogen supply path 32. Moreover, the released fluid includes therein water vapor that is vaporized by the heat of the water electrolysis stack 12 or the like.

The released fluid (the hydrogen gas and unreacted water) that is output to the first hydrogen supply path 32 from the water electrolysis stack 12 flows into the gas/liquid separator 14. The gas/liquid separator 14 separates the released fluid into gas components (hydrogen gas and water vapor) and liquid components (liquid water). The gas components, by turning ON a pump 34 (a hydrogen circulation pump) of the first hydrogen supply path 32 that is provided on an outlet side of the gas/liquid separator 14, pass through the first hydrogen supply path 32 and are supplied to the hydrogen compression stack 18.

Moreover, the hydrogen gas that flows through the first hydrogen supply path 32 and is supplied to the hydrogen compression stack 18 passes through the stored water within the gas/liquid separator 14 via a pipe (not shown), and is supplied from the gas/liquid separator 14 to the first hydrogen supply path 32. On the first hydrogen supply path 32, a pressure sensor 60 is provided in close proximity to the outlet of the gas/liquid separator 14.

Furthermore, between the outlet of the gas/liquid separator 14 and the inlet of the hydrogen compression stack 18, the pressure sensor 60, the pump 34, and an oxygen remover 33 are provided in this order from the outlet.

In the oxygen remover 33, the cross-leaked oxygen gas (to be described later) that is discharged from the water electrolysis stack 12 into the gas/liquid separator 14, and the hydrogen gas that is discharged from the hydrogen compression stack 18 through a hydrogen discharge path 35 into the gas/liquid separator 14 are made to react by means of an oxygen removal catalyst and thereby produce water.

A check valve 36 is disposed in the hydrogen discharge path 35 of the hydrogen compression stack 18. The hydrogen gas that is discharged from the hydrogen compression stack 18 to the gas/liquid separator 14 through the hydrogen discharge path 35 passes through the stored water and is supplied to a gas storage chamber of the gas/liquid separator 14.

### Hydrogen Compression Stack 18

The hydrogen compression stack 18 includes a membrane electrode assembly (MEA) (a hydrogen compression membrane electrode assembly) 21m in which an electrolyte membrane 21e is sandwiched between an anode 21a and a cathode 21c. The electrolyte membrane 21e that is used in the hydrogen compression stack 18 is a proton exchange membrane. An electrical power source device (a hydrogen compression electrical power source device) 19 is connected between the anode 21a and the cathode 21c.

The control device 28 is capable of variably controlling an electrical current (a hydrogen pressure rising electrical current) Iehc (hereinafter referred to as an EHC electrical current Iehc) from the electrical power source device 19 that is supplied between the anode 21a and the cathode 21c. The electrical power source device 19 may use the electrical power of the battery 23.

The value of the EHC electrical current Iehc that is supplied to the anode 21a from the electrical power source device 19 is detected by an electrical current sensor 93.

The value of a cell voltage Vehc, which is the voltage applied to the membrane electrode assembly 21m (the unit cell), is detected as the stack voltage by a voltage sensor 94. The control device 28 acquires the stack voltage and stores the cell voltage Vehc obtained by the stack voltage by the number of cells.

Moreover, in the present embodiment, the number of cells, and the cell area of the hydrogen compression stack 18 are the same as the number of cells and the cell area of the water electrolysis stack 12.

The hydrogen compression stack 18 supplies to the anode 21a the hydrogen gas that flows in from the first hydrogen supply path 32. The hydrogen compression stack 18 ionizes the hydrogen gas based on the EHC electrical current Iehc that is supplied from the electrical power source device 19. Protons that are obtained by the ionization of the hydrogen gas are accompanied by water and reach the cathode 21c through the electrolyte membrane (the proton exchange membrane) 21e. The protons that reach the cathode 21c combine with electrons that are supplied from the electrical power source device 19 (electrons generated at the time of being ionized) and are returned to the hydrogen gas.

The hydrogen compression stack 18, by transferring the protons from the anode 21a to the cathode 21c, generates a compressed hydrogen gas. For example, the hydrogen gas is compressed to a pressure within a range of from 1 to 100 MPa. In this manner, the hydrogen compression stack 18 serves as an electrochemical hydrogen compressor (EHC) that is capable of electrochemically compressing the hydrogen gas.

A reaction formula on the side of the cathode 21c of the hydrogen compression stack 18 is shown below.

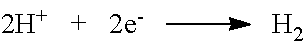

A reaction formula on the side of the anode 21a of the hydrogen compression stack 18 is shown below.

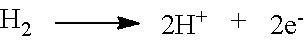

The hydrogen compression stack 18 outputs excess hydrogen gas that has not been ionized to the hydrogen discharge path 35. The hydrogen discharge path 35 is a flow path (piping) for the purpose of discharging the hydrogen gas from the hydrogen compression stack 18 to the gas/liquid separator 14.

At a time when the high pressure oxygen is accumulated in the oxygen tank 16 and at a time when the high pressure hydrogen is accumulated in the hydrogen tank 20, the molar ratio of hydrogen to oxygen becomes 2:1. The hydrogen compression stack 18 outputs a released gas that contains the compressed hydrogen gas to the hydrogen supplying mechanism 17B. Moreover, the released gas includes therein water vapor that is vaporized by the heat of the hydrogen compression stack 18 or the like.

### Gas Supplying Mechanism 17

The gas supplying mechanism 17 is constituted by the oxygen supplying mechanism 17A and the hydrogen supplying mechanism 17B. The gas supplying mechanism 17 is a mechanism for the purpose of supplying gases (the hydrogen gas and the oxygen gas) to the fuel cell 22.

The oxygen supplying mechanism 17A supplies to the fuel cell 22 the oxygen gas that is generated in the water electrolysis stack 12. The hydrogen supplying mechanism 17B supplies to the fuel cell 22 the hydrogen gas that is generated in the hydrogen compression stack 18.

Shutoff valves 47 and 49 that constitute the oxygen supplying mechanism 17A and shutoff valves 48 and 50 that constitute the hydrogen supplying mechanism 17B are each respectively opening/closing valves. In the present embodiment, as the opening/closing valves, there are used solenoid valves that are opened (at a time of being driven ON) and that are closed (at a time of being driven OFF) by an opening/closing drive control of the control device 28.

### Oxygen Supplying Mechanism 17A

The oxygen supplying mechanism 17A includes the oxygen supply path 43, the oxygen tank 16, a bypass path 45, a shutoff valve 47, the shutoff valve 49, a pressure reducing valve 51, a pressure reducing valve 58, a back pressure valve 57, a pressure sensor 61, and a temperature sensor 63.

The oxygen supply path 43 is a path for the purpose of supplying the high pressure oxygen gas that is generated in the water electrolysis stack 12 to the fuel cell 22 via the oxygen tank 16. One end of the oxygen supply path 43 is connected to the water electrolysis stack 12, and the other end of the oxygen supply path 43 is connected to the fuel cell 22.

The oxygen tank 16 is disposed on the oxygen supply path 43. The high pressure oxygen gas that is generated by the water electrolysis stack 12 is stored in the oxygen tank 16.

The bypass path 45 branches off from a branching portion Bpo (BP) of the oxygen supply path 43 between the water electrolysis stack 12 and the oxygen tank 16, and merges at a merging portion Mpo (MP) of the oxygen supply path 43 between the oxygen tank 16 and the fuel cell 22.

The shutoff valve 47 is disposed on the bypass path 45. The shutoff valve 49 is disposed in the oxygen supply path 43 between the merging portion Mpo and the oxygen tank 16. The pressure reducing valve 51 is disposed in the oxygen supply path 43 between the merging portion Mpo and the oxygen tank 16. The pressure reducing valve 51 reduces to a predetermined pressure the pressure of the oxygen gas that is supplied from the oxygen tank 16.

The back pressure valve 57 is disposed in the oxygen supply path 43 between the branching portion Bpo and the oxygen tank 16. The back pressure valve 57 applies a pressure (a back pressure) to the water electrolysis stack 12 using the oxygen tank 16. In accordance with this feature, the pressure of the oxygen gas that is generated at the anode 15a of the electrolyte membrane 15e of each of the unit cells of the water electrolysis stack 12 rises, and becomes higher than the pressure of the hydrogen gas that is generated at the cathode 15c.

The water electrolysis stack 12 generates the oxygen gas at the anode 15a, the pressure of which is higher than that of the hydrogen gas that is generated at the cathode 15c. Accordingly, it is possible to suppress cross leakage, which is defined as permeation of the hydrogen gas through the electrolyte membrane 15e from the cathode 15c to the anode 15a. As a result, it is possible to prevent a decrease in the amount of the hydrogen gas that is supplied from the water electrolysis stack 12 to the hydrogen compression stack 18.

The pressure sensor 61 is disposed in the oxygen supply path 43 between the water electrolysis stack 12 and the branching portion Bpo. The pressure sensor 61 detects the pressure of the oxygen gas that is supplied from the water electrolysis stack 12 to the oxygen supply path 43. The pressure sensor 61 outputs a signal indicating the pressure that was detected to the control device 28.

The temperature sensor 63 is disposed in the oxygen supply path 43 in close proximity to the water electrolysis stack 12. The temperature sensor 63 detects the temperature of the oxygen gas that is supplied from the water electrolysis stack 12 to the oxygen supply path 43. The temperature sensor 63 outputs a signal indicating the temperature that was detected to the control device 28.

The compressed oxygen gas that was released from the water electrolysis stack 12 to the oxygen supply path 43, in addition to the oxygen gas, contains water vapor therein produced by a reaction at the anode 15a.

The gas/liquid separator 14 stores the water to be supplied to the water electrolysis stack 12. The water supply path 30 is disposed between the gas/liquid separator 14 and the water electrolysis stack 12. The pump 31 is disposed on the water supply path 30.

The oxygen supplying mechanism 17A further includes an oxygen exhaust gas path 76, a gas/liquid separator 24, a circulation pump 70, and a drain valve 72.

### Hydrogen Supplying Mechanism 17B

The hydrogen supplying mechanism 17B includes a second hydrogen supply path 44, the hydrogen tank 20, a bypass path 46, the shutoff valve 48, the shutoff valve 50, a pressure reducing valve 52, a pressure reducing valve 56, a back pressure valve 59, a pressure sensor 62, and a temperature sensor 69.

The second hydrogen supply path 44 is a path for the purpose of supplying the hydrogen gas that was compressed in the hydrogen compression stack 18 to the fuel cell 22 via the hydrogen tank 20. One end of the second hydrogen supply path 44 is connected to the hydrogen compression stack 18, and the other end of the second hydrogen supply path 44 is connected to the fuel cell 22.

The hydrogen tank 20 is disposed on the second hydrogen supply path 44. The hydrogen gas that has been raised in pressure by the hydrogen compression stack 18 is stored in the hydrogen tank 20.

The bypass path 46 branches off from a branching portion Bph (BP) of the second hydrogen supply path 44 between the hydrogen compression stack 18 and the hydrogen tank 20, and merges at a merging portion Mph (MP) of the second hydrogen supply path 44 between the hydrogen tank 20 and the fuel cell 22.

An opening/closing valve (the shutoff valve) 48 is disposed in the bypass path 46. The opening/closing valve (the shutoff valve) 50 is disposed in the second hydrogen supply path 44 between the merging portion Mph and the hydrogen tank 20.

The pressure reducing valve 52 is disposed in the second hydrogen supply path 44 between the merging portion Mph and the hydrogen tank 20. The pressure reducing valve 52 reduces to a predetermined pressure the pressure of the hydrogen gas that is supplied from the hydrogen tank 20.

The back pressure valve 59 is disposed in the second hydrogen supply path 44 between the branching portion Bph and the hydrogen tank 20. The back pressure valve 59 applies a pressure (a back pressure) to the hydrogen compression stack 18. In accordance with this feature, the pressure of the hydrogen gas that is generated at the cathode 21c of each of the unit cells of the hydrogen compression stack 18 rises, and becomes higher than the pressure of the hydrogen gas that is supplied to the anode 21a.

The hydrogen compression stack 18 generates the hydrogen gas at the cathode 21c at a pressure that is higher than that of the hydrogen gas that is supplied to the anode 21a. Accordingly, it is possible to suppress cross leakage, which is defined as permeation of the hydrogen gas through the electrolyte membrane 21e from the cathode 21c to the anode 21a.

The pressure sensor 62 is disposed in the second hydrogen supply path 44 in close proximity to the branching portion Bph. The pressure sensor 62 detects the pressure of the compressed hydrogen gas that is supplied to the second hydrogen supply path 44. The pressure sensor 62 outputs a signal indicating the pressure that was detected to the control device 28.

The temperature sensor 69 is disposed in the second hydrogen supply path 44 in close proximity to the hydrogen compression stack 18. The temperature sensor 69 detects the temperature of the hydrogen gas that is supplied from the hydrogen compression stack 18 to the second hydrogen supply path 44. The temperature sensor 69 outputs a signal indicating the temperature that was detected to the control device 28.

The hydrogen supplying mechanism 17B further includes a hydrogen exhaust gas path 77, a gas/liquid separator 26, a circulation pump 71, and a drain valve 73.

### Fuel Cell 22

The fuel cell 22 has a stack made up from a plurality of unit cells that are electrically connected in series. Each of the unit cells includes a membrane electrode assembly (MEA) in which an electrolyte membrane is sandwiched between an anode and a cathode.

In the fuel cell 22, the oxygen gas, which is supplied from the oxygen tank 16, via the shutoff valve 49 and the pressure reducing valve 51 is supplied to the cathode of each of the unit cells.

In the fuel cell 22, the hydrogen gas, which is supplied from the hydrogen tank 20, via the shutoff valve 50 and the pressure reducing valve 52 is supplied to the anode of each of the unit cells. Each of the unit cells of the fuel cell 22 generates electricity through an electrochemical reaction between the oxygen gas and the hydrogen gas.

A reaction formula on the side of the anode of the fuel cell 22 is shown below.

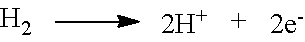

A reaction formula on the side of the cathode of the fuel cell 22 is shown below.

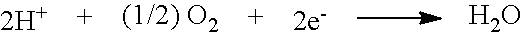

The electrical power generated by the fuel cell 22, together with being supplied to a non-illustrated load (such as an external actuator or an electrical appliance or the like), is also supplied to an auxiliary load including the control device 28. A surplus generated electrical power is charged to the battery 23. A generated electrical current of the fuel cell 22 is detected by an electrical current sensor 27, and is acquired by the control device 28. Moreover, the stored voltage of the battery 23 and the generated voltage of the fuel cell 22 are detected by non-illustrated voltage sensors, and the voltage sensors output signals indicating the voltages that are detected to the control device 28.

An oxygen containing exhaust gas, which contains an unreacted oxygen gas in each of the unit cells of the fuel cell 22, is supplied via an oxygen circulation path 66 to the oxygen supply path 43. The oxygen circulation path 66 is a flow path for the purpose of returning the oxygen containing exhaust gas that is discharged from the fuel cell 22 to the oxygen supply path 43.

The gas/liquid separator 24 and the circulation pump 70 are disposed on the oxygen circulation path 66. The gas/liquid separator 24 separates the oxygen containing exhaust gas, which is discharged from the fuel cell 22 into the oxygen exhaust gas path 76, into a gas component (oxygen gas and water vapor) and a liquid component (liquid water). The gas component is supplied again to the fuel cell 22 by the circulation pump 70. On the other hand, the liquid component is supplied to the gas/liquid separator 14 via the drain valve 72, which is an opening/closing valve, and a pump 25, which is disposed on a water supply path 29 and is turned ON.

On the other hand, a hydrogen containing exhaust gas, which contains an unreacted hydrogen gas in each of the unit cells of the fuel cell 22, is supplied via a hydrogen circulation path 67 to the second hydrogen supply path 44. The hydrogen circulation path 67 is a flow path for the purpose of returning the hydrogen containing exhaust gas that is discharged from the fuel cell 22 to the second hydrogen supply path 44.

The gas/liquid separator 26 and the circulation pump 71 are disposed on the hydrogen circulation path 67. The gas/liquid separator 26 separates the hydrogen containing exhaust gas, which is discharged from the fuel cell 22 into the hydrogen exhaust gas path 77, into a gas component (hydrogen gas and water vapor) and a liquid component (liquid water). The gas component is supplied again to the fuel cell 22 by the circulation pump 71. On the other hand, the liquid component is supplied to the gas/liquid separator 14 via the drain valve 73, which is an opening/closing valve, and the pump 25, which is turned ON.

The water that is generated in the fuel cell 22 is supplied to the gas/liquid separator 14, via the gas/liquid separator 24, the gas/liquid separator 26, the drain valve 72, the drain valve 73, and the pump 25 that is on the water supply path 29.

### Control Device 28

The control device 28 controls all of the constituent elements of the regenerative fuel cell system 10, and executes the operation of the regenerative fuel cell system 10 including the water electrolysis system 11.

The control device 28 is a computer that controls the regenerative fuel cell system 10 (including the water electrolysis system 11). The control device 28 includes a storage medium (a memory) and at least one processor that executes a computer executable instruction that is stored in the memory, and the storage medium can be constituted by a volatile memory and a non-volatile memory. As an example of the processor, there may be cited a CPU, an MCU, or the like. As an example of the volatile memory, there may be cited a RAM or the like. As an example of the nonvolatile memory, there may be cited a ROM, a flash memory, or the like. The control device 28 turns ON the pump 31, and thereby supplies the water from the gas/liquid separator 14 to the water electrolysis stack 12.

The control device 28 turns ON the electrical power source device 13, and thereby supplies the EC current Iec from the electrical power source device 13 to the anode 15a and the cathode 15c of the unit cells of the water electrolysis stack 12.

In accordance with this feature, the water electrolysis stack 12 enters into an operating state (a pressure rising state, a water electrolysis state), and carries out the electrolysis of water (water electrolysis).

When the control device 28 turns OFF the electrical power source device 13 and suspends the supply of the EC electrical current Iec from the electrical power source device 13 to the unit cells and the supply of the water to the water electrolysis stack 12, the water electrolysis stack 12 enters into a non-operating state (a depressurizing state, and then a suspended state).

Further, the control device 28 turns ON the electrical power source device 19 and thereby supplies the EHC electrical current Iehc from the electrical power source device 19 to the unit cells of the hydrogen compression stack 18. In addition thereto, the control device 28 turns ON the pump 34, and by means of the pump 34, supplies the hydrogen gas, via the first hydrogen supply path 32 and the gas/liquid separator 14, from the water electrolysis stack 12 to the hydrogen compression stack 18.

In accordance with this feature, the hydrogen compression stack 18 enters into an operating state (a pressure rising state), and increases the pressure of the hydrogen gas. When the control device 28 turns OFF the electrical power source device 19 and suspends the supply of the EHC electrical current Iehc from the electrical power source device 19 to the unit cells and the supply of the hydrogen gas to the hydrogen compression stack 18, the hydrogen compression stack 18 enters into a non-operating state (a depressurizing state, and then a suspended state).

### Control Processes of Water Electrolysis System 11 and Regenerative Fuel Cell System 10

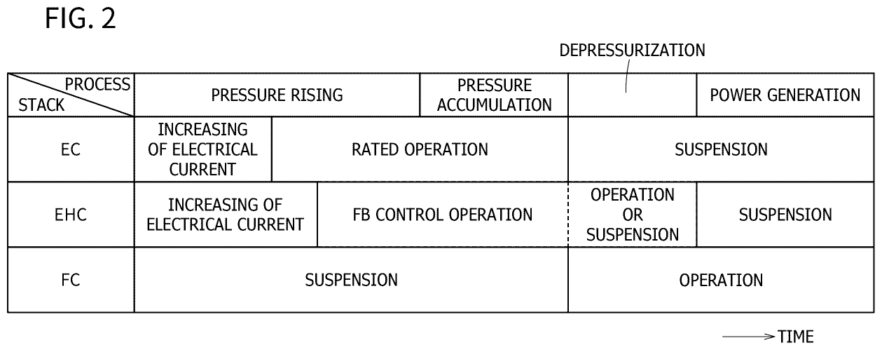

FIG. 2 is an operational transition process diagram showing control processes of the regenerative fuel cell system 10 (RFC) by the control device 28, and operating and suspended states of the water electrolysis stack 12 (EC), the hydrogen compression stack 18 (EHC), and the fuel cell 22 (FC) during each of the respective control processes. In this instance, a description will be given in outline with reference to FIG. 2 of each of the control processes of the regenerative fuel cell system 10 (RFC).

As shown in FIG. 2, the regenerative fuel cell system 10, as the control processes executed by the control device 28, executes from the pressure rising mode process, a pressure accumulation mode process, a depressurization mode process, and an electrical power generation mode process. Thereafter, from the pressure rising mode process up until the electrical power generation mode process, the processes are repeatedly executed. In the pressure rising mode process, the control device 28 raises to predetermined pressures an output pressure (an anode pressure) of the water electrolysis stack 12 and an output pressure (a cathode pressure) of the hydrogen compression stack 18. In the pressure accumulation mode process, the control device 28 accumulates the oxygen gas and the hydrogen gas at respective predetermined pressures in the oxygen tank 16 and the hydrogen tank 20 until they reach a predetermined pressures. In the depressurization mode process, the control device 28 depressurizes to zero the anode pressure of the water electrolysis stack 12 and the cathode pressure of the hydrogen compression stack 18.

In the depressurization mode process, the control device 28 suspends the operation of the water electrolysis stack 12, and operates or suspends the operation of the hydrogen compression stack 18. In this depressurization mode process, the fuel cell 22 is operated (generates electrical power) in an auxiliary manner to consume the oxygen gas that remains in the oxygen supply path 43 that communicates with the anode 15a of the water electrolysis stack 12 and consume the hydrogen gas that remains in the second hydrogen supply path 44 that communicates with the cathode 21c of the hydrogen compression stack 18.

In accordance with this feature, at the time of the electrical power generation mode process, the pressure at the anode 15a of the water electrolysis stack 12 that is suspended becomes zero and the pressure at the cathode 21c of the hydrogen compression stack 18 that is suspended also becomes zero.

Regions on sides at which the oxygen is supplied where the high pressure oxygen gas remains and where depressurization thereof is required are a region of the oxygen supply path 43 from the anode 15a of the water electrolysis stack 12 to a primary side of the back pressure valve 57 that communicates with the anode 15a, and a region from the anode 15a of the water electrolysis stack 12 to a primary side of the pressure reducing valve 58.

Regions on sides at which the hydrogen is supplied where the high pressure hydrogen gas remains and where depressurization thereof is required are a region of the second hydrogen supply path 44 from the cathode 21c of the hydrogen compression stack 18 to a primary side of the back pressure valve 59 that communicates with the cathode 21c, and a region from the cathode 21c of the hydrogen compression stack 18 to a primary side of the pressure reducing valve 56.

Moreover, when the depressurization mode process is executed, as a cause of the fact that 2 [mol] of hydrogen is consumed with respect to every 1 [mol] of oxygen due to the electrochemical reaction in the fuel cell 22, the hydrogen in the hydrogen depressurization region is completely consumed prior to the oxygen in the oxygen depressurization region.

The hydrogen gas is supplied from the hydrogen tank 20 to the fuel cell 22 to make up for the shortage of the hydrogen gas inside the hydrogen depressurization region. In this manner, the high pressure oxygen gas in the oxygen depressurization region can be completely consumed.

During the above-described depressurization mode process, pressure difference is generated in each of the electrolyte membrane 15e of the water electrolysis stack 12 and the electrolyte membrane 21e of the hydrogen compression stack 18. Due to such a pressure difference, cross leakage occurs from a high pressure side to a low pressure side of each of the water electrolysis stack 12 and the hydrogen compression stack 18 (cross leakage of oxygen that permeates in a reverse direction through the electrolyte membrane 15e of the water electrolysis stack 12, and cross leakage of hydrogen that permeates in a reverse direction through the electrolyte membrane 21e of the hydrogen compression stack 18). It is necessary for the cross leaked oxygen and the cross leaked hydrogen to be depressurized (disposed of).

Regarding the cross leakage of the oxygen in the water electrolysis stack 12, the hydrogen that remains in the gas/liquid separator 14 and the cross leaked hydrogen that is supplied from the hydrogen compression stack 18 to the gas/liquid separator 14 through the hydrogen discharge path 35, and the cross leaked oxygen that is supplied from the water electrolysis stack 12 to the gas/liquid separator 14 through the first hydrogen supply path 32 are made to react in the oxygen remover 33 which is equipped with the oxygen removal catalyst, thereby producing water and bringing about depressurization.

When the reaction is carried out in the oxygen remover 33, the pump 34 is turned ON, thereby causing the oxygen that has cross leaked in the first hydrogen supply path 32 and the hydrogen to circulate. In general, hydrogen is more cross leaked than oxygen since the molecules of hydrogen are smaller. Therefore, the hydrogen gas remains on the primary side of the hydrogen compression stack 18 that communicates with the hydrogen discharge path 35, and specifically in the gas/liquid separator 14, and the pressure on the side of the anode 21a of the hydrogen compression stack 18 rises.

Thus, regarding the hydrogen gas that has remained, the EHC current Iehc is supplied from the electrical power source device 19 to the hydrogen compression stack 18 during the depressurization process, and the hydrogen gas that remains on the side of the anode 21a is increased in pressure and transferred to the side of the cathode 21c. The high pressure hydrogen gas that has been raised in pressure on the side of the cathode 21c can be consumed by the depressurization process in the hydrogen depressurization region that was described above. In the electrical power generation mode process after the depressurization mode process, the oxygen gas and the hydrogen gas that are accumulated in the oxygen tank 16 and the hydrogen tank 20 are supplied to the fuel cell 22, and the fuel cell 22 is made to operate and generate electrical power by means of the electrochemical reaction in the fuel cell 22.

In the regenerative fuel cell system 10, as noted previously, after the electrical power generation mode process, the system returns to the pressure rising mode process, and each of the mode processes is repeated. Moreover, at a time when the water electrolysis system 11 is initiated, and more specifically, at a time when the pressure rising mode process is initiated, a non-illustrated electrical power switch is switched from an OFF state to an ON state, and at a time when the electrical power generation mode process comes to an end, is switched from the ON state to the OFF state.

On the other hand, the hydrogen compression stack 18 is placed in a suspended state from the point in time that the electrical power generation mode process is started. During the suspended state (during the non-operating state), due to changes in the outside air temperature or the like, there may be cases in which flooding takes place on the side of the anode 21a of the hydrogen compression stack 18.

### Description of Operations of Embodiments

The water electrolysis system 11 is basically configured in the manner described above. The present invention has the object of eliminating the flooding of the hydrogen compression stack 18 at the time when the water electrolysis system 11 is initiated in the pressure rising mode process.

### First Exemplary Embodiment

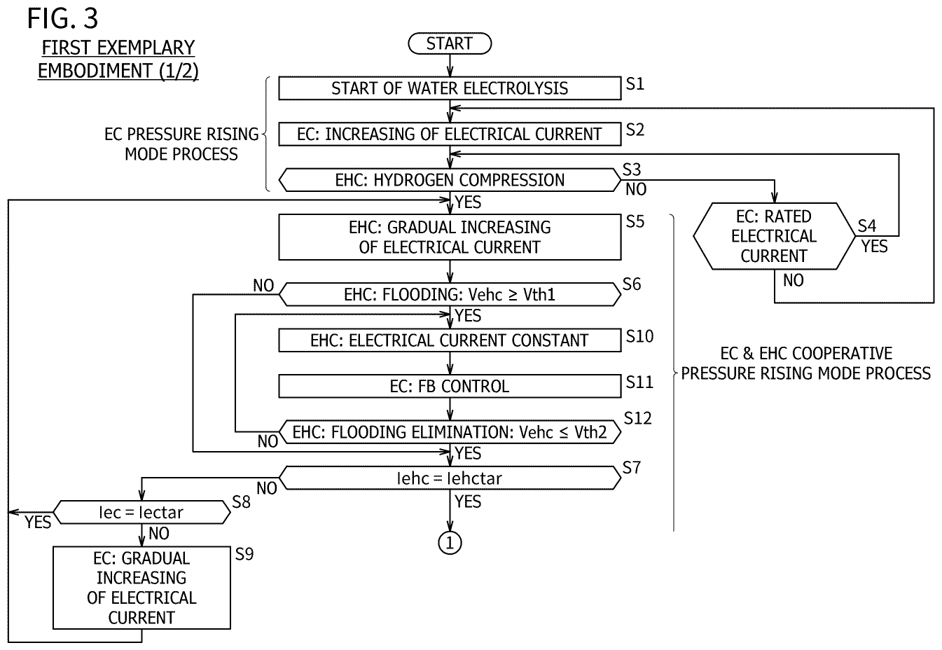

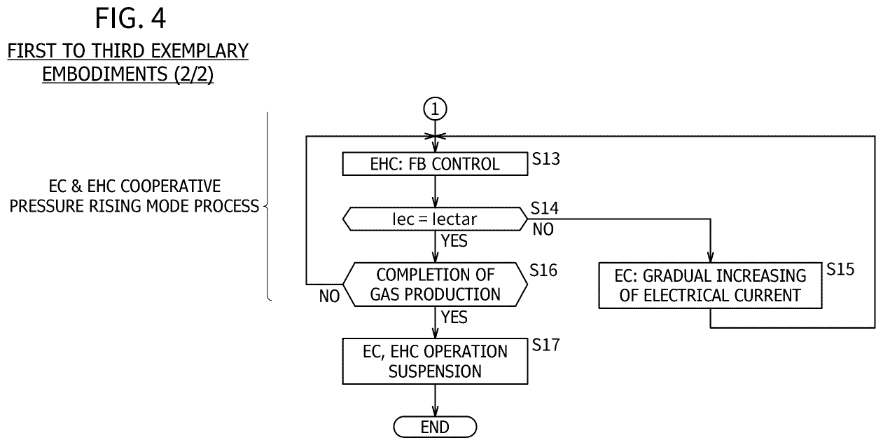

Next, with reference to the flowchart of a first exemplary embodiment that is divided into FIG. 3 and FIG. 4, a description will be given concerning a flooding elimination control of the hydrogen compression stack 18 at a time of initiation of the pressure rising mode process of the water electrolysis system 11. The flowchart of FIG. 3 and FIG. 4 is executed at a time of starting (a time of initiation) of an “electrical current increasing” control process during the pressure rising mode process shown in FIG. 2.

In FIG. 3, the process of steps S1 to S4 corresponds to a process of causing only the water electrolysis stack 12 to be operated, and thereby raising the pressure of the oxygen (hereinafter, referred to as an EC pressure rising mode process).

In FIG. 3 and FIG. 4, the process of steps S5 to S16 corresponds to a process of raising the pressure of the hydrogen by the hydrogen compression stack 18 in coordination with a process of raising the pressure of the oxygen by the water electrolysis stack 12 (hereinafter referred to as an EC & EHC cooperative pressure rising mode process).

Moreover, in the flowchart of FIG. 3 and FIG. 4, the depressurization mode process and the electrical power generation mode process after completion of the production of gas in step S16 are omitted.

In step S1, when a non-illustrated power switch is turned ON, the control device 28, together with turning ON the pump 31 and starting the supply of the water from the gas/liquid separator 14 to the water electrolysis stack 12, also turns ON the electrical power source device 13 and starts supplying the EC electrical current Iec to the membrane electrode assembly 15m of the water electrolysis stack 12.

In accordance with this feature, the water electrolysis in the water electrolysis stack 12 is initiated, and the control device 28 advances the process to step S2.

In step S2, the control device 28, by operating the electrical power source device 13 and thereby increasing the EC current Iec, supplies the hydrogen gas (including the water) that is generated in the water electrolysis stack 12 to the gas/liquid separator 14 via the first hydrogen supply path 32, whereupon the process advances to step S3.

In step S3, the control device 28 determines a timing for starting the initiation of the hydrogen compression stack 18. Specifically, in a state with the pump 34 being turned ON and operating, by using the pressure sensor 60, at first, the control device 28 detects the pressure of the hydrogen gas in the first hydrogen supply path 32. Next, the control device 28 determines whether or not the gas pressure that was detected has increased in pressure to a predetermined pressure value that is capable of enabling the hydrogen compression stack 18 to be operated in a stable manner. In this instance, the pressure of the hydrogen gas inside the first hydrogen supply path 32 that is detected by the pressure sensor 60 is equal to the pressure inside the gas/liquid separator 14. Moreover, at the time of initiation when the operation of the pump 34 is started, oxygen that has accumulated on the side of the cathode 15c of the water electrolysis stack 12 flows into the oxygen remover 33 via the first hydrogen supply path 32, the gas/liquid separator 14, and the pump 34. In this case, the hydrogen that is generated in the water electrolysis stack 12 also flows into the oxygen remover 33. The oxygen remover 33 removes the oxygen by causing the oxygen and the hydrogen that flow therein to react by means of the oxygen removal catalyst and thereby form water.

In the case that the pressure in the first hydrogen supply path 32 has not been increased to the predetermined pressure value (step S3: NO), then in step S4, the control device 28 determines whether or not the EC electrical current Iec has increased to a rated current in accordance with the value detected by the electrical current sensor 91.

In the case that the EC electrical current Iec has not increased to the rated current (step S4: NO), then in step S2, the control device 28 gradually increases the EC electrical current Iec at a predetermined gradient G (G=ΔIec/Δt), and in step S3, continues increasing the pressure of the hydrogen gas in the first hydrogen supply path 32 to the predetermined pressure value. In the case that the electrical current has increased to the rated current (step S4: YES), the process returns to step S3.

In step S3, at a time when the pressure of the hydrogen gas inside the first hydrogen supply path 32 (the gas/liquid separator 14) has been increased to the predetermined pressure value (step S3: YES), the control device 28 brings the EC pressure rising mode process to an end, and then in step S5 and thereafter, proceeds to the EC & EHC cooperative pressure rising mode process.

In this manner, by the water electrolysis stack 12 operating independently, the hydrogen gas intended to be supplied to the hydrogen compression stack 18 through the EC pressure rising mode process is filled into the first hydrogen supply path 32 (the gas/liquid separator 14).

Moreover, in step S1, the EC electrical current Iec that is supplied from the electrical power source device 13 to the water electrolysis stack 12 is set to zero. Further, in step S3, the EHC electrical current Iehc that is supplied from the electrical power source device 19 to the hydrogen compression stack 18 is also set to zero.

In step S5, the control device 28 gradually increases the EHC electrical current Iehc of the hydrogen compression stack 18 at a predetermined gradient G (G=ΔIehc/Δt), whereupon the process advances to step S6.

In step S6, the control device 28 determines the presence or absence of flooding in accordance with whether or not the cell voltage (referred to as an EHC cell voltage) Vehc of the hydrogen compression stack 18 that is detected by the voltage sensor 94 has reached a first voltage threshold value (a membrane protective voltage) Vth1.

In a first determination, since flooding is not occurring (step S6: NO, Vehc<Vth1), the control device 28 advances the process to step S7.

In step S7 and step S8, the control device 28 determines whether the EHC electrical current Iehc and the EC electrical current Iec have reached their respective target electrical currents (an EHC target electrical current Iehctar, and an EC target electrical current Iectar). In the first determination, since the target electrical currents have not been reached (step S7: NO, step S8: NO), the control device 28 advances the process to step S9.

In step S9, the control device 28 gradually increases the EC electrical current Iec of the water electrolysis stack 12 at the same gradient as the predetermined gradient G ((ΔIec/Δt)=(ΔIehc/Δt)=G) in coordination with (in synchronization with) the EHC electrical current Iehc of the hydrogen compression stack 18, and then the process advances to step S5.

In this manner, the EC electrical current Iec and the EHC electrical current Iehc gradually increase from zero simultaneously and in coordination (in synchronization or in conformity) at the predetermined gradient G toward the EC target electrical current Iectar and the EHC target electrical current Iehctar (step S5→step S6: NO→step S7: NO→step S8: NO→step S9).

While the EC electrical current Iec and the EHC electrical current Iehc are simultaneously and cooperatively increasing respectively at the predetermined gradient G from zero toward the EC target electrical current Iectar and the EHC target electrical current Iehctar, the determination of flooding in step S6 becomes positive (step S6: YES, Vehc≥ Vth1).

More specifically, at the time when the cell voltage Vehc of the hydrogen compression stack 18 has risen to the first voltage threshold value Vth1, which is the membrane protective voltage, the determination of flooding becomes positive.

At this time, in step S10, the control device 28 temporarily suspends the increasing of the EHC electrical current Iehc, and maintains the EHC electrical current Iehc at the time when the determination of flooding became positive as a constant current value. More specifically, the control device 28 maintains the EHC electrical current Iehc at the time when the determination of flooding became positive as the constant current value, and then the process advances to step S11.

In step S11, accompanying the control of the EHC electrical current Iehc in step S10, the EC electrical current Iec is feedback (FB) controlled in a manner so that the pressure in the gas/liquid separator 14 becomes a predetermined pressure.

More specifically, in step S11, the control device 28 maintains the EC electrical current Iec at the time when the determination of flooding became positive as a constant current value, and then the process advances to step S12. In the process of step S11, the control device 28 causes the EC electrical current Iec of the water electrolysis stack 12 to change in a manner so that the pressure of the hydrogen gas inside the first hydrogen supply path 32 (the gas/liquid separator 14) becomes a predetermined pressure. More specifically, in the water electrolysis stack 12, since the hydrogen and the oxygen are generated in a ratio of 2 moles to 1 mole, the pressure of the hydrogen that is supplied to the hydrogen compression stack 18 increases rapidly. Therefore, at this point in time, due to crossover occurring in the hydrogen compression stack 18, there is a possibility that the hydrogen pressure on the low pressure side (the side of the anode 21a) will become higher than the hydrogen pressure on the high pressure side (the side of the cathode 21c). Accordingly, it is necessary to control the EC electrical current Iec of the water electrolysis stack 12. In this manner, the cell voltage Vehc of the hydrogen compression stack 18 starts to decrease at a negative gradient.

In step S12, the control device 28, by determining whether or not the cell voltage Vehc of the hydrogen compression stack 18 has decreased to a second voltage threshold value (a flooding elimination voltage) Vth2 (Vehc≤Vth2), determines whether or not the flooding has been eliminated.

The processes of step S10 to step S12 are repeated until the flooding has been eliminated in step S12 (step S12: YES).

At a time when the determination in step S12 is positive (step S12: YES, Vehc≤Vth2), then in step S9 and step S5, the control device 28 coordinates the EC electrical current Iec of the water electrolysis stack 12 and the EHC electrical current Iehc of the hydrogen compression stack 18, and once again, causes them to gradually increase at the same gradient G.

In practice, during the EC & EHC cooperative pressure rising mode process, the EHC electrical current Iehc and the EC electrical current Iec increase (arrive) respectively in a stepwise manner at the same timing from zero to the EHC target electrical current Iehctar and the EC target electrical current Iectar.

During the EC and EHC cooperative pressure rising mode process, at a time when the flooding is eliminated in step S12 (step S12: YES, Vehc≤Vth2 which will be described later), and at a time when the EHC electrical current Iehc reaches the EHC target electrical current Iehctar in step S7 (step S7: YES), the control device 28 advances the process to step S13 shown in FIG. 4. In step S13, the control device 28 carries out a feedback control (an FB control) of the EHC electrical current Iehc of the hydrogen compression stack 18 in a manner so that the pressure in the gas/liquid separator 14 becomes a predetermined pressure, whereupon the process advances to step S14. In step S14, the control device 28 determines whether or not the EC electrical current Iec of the hydrogen compression stack 18 has reached the EC target electrical current Iectar. In the case that the EC electrical current Iec has not reached the EC target electrical current Iectar (step S14: NO), then in step S15, the control device 28 gradually causes the EC electrical current Iec of the water electrolysis stack 12 to increase, and the process returns to step S13. In step S14, in the case that the EC electrical current Iec of the water electrolysis stack 12 has reached the EC target electrical current Iectar (step S14: YES), the control device 28 advances the process to step S16. More specifically, during the execution of the EC and EHC cooperative pressure rising mode process, the EHC electrical current Iehc and the EC electrical current Iec reach the EHC target electrical current Iehctar and the EC target electrical current Iectar, and at the time when the determinations in step S7 and step S14 have become positive, the control device 28 advances the process to step S16.

When the process advances to step S16, the EC & EHC cooperative pressure rising mode process comes to an end, the process enters into the pressure accumulation mode process, and the control device 28 repeats the processes of step S13 to step S16. A predetermined amount of the hydrogen or the oxygen is stored in the hydrogen tank 20 and the oxygen tank 16, and if the predetermined pressure is reached, the determination in step S16 becomes positive (step S16: YES), and the production of gas is completed.

In this instance, the FB control of the hydrogen compression stack 18 causes the pressure of the hydrogen gas inside the first hydrogen supply path 32 (the gas/liquid separator 14) to change so as to become a predetermined pressure.

More specifically, in the case that the EC electrical current Iec is lower than the EC target electrical current Iectar (step S14: NO), then in step S15, the control device 28 gradually causes the EC electrical current Iec to increase. On the other hand, in the case that the EC electrical current Iec is maintained at the EC target electrical current Iectar (step S14: YES), then in step S16, the control device 28 determines whether or not the production of gas is complete, and in the case of the production of gas not being complete (step S16: NO), continues the FB control of the EHC electrical current Iehc of step S13.

Moreover, the determination of the completion of the production of gas in step S16, as noted previously, is made positive (step S16: YES) at a time when the tank pressure of the hydrogen tank 20 or the oxygen tank 16 reaches a predetermined pressure, whereupon the control device 28 advances the process to step S17.

In step S17, in the pressure accumulation mode process (FIG. 2), the control device 28 suspends the operation of the water electrolysis stack 12 and the hydrogen compression stack 18. Thereafter, the depressurization mode process and the electrical power generation mode process that were described with reference to FIG. 2 are executed.

### Time Chart of EC & EHC Cooperative Pressure Rising Mode Process

### (Initiation Process)

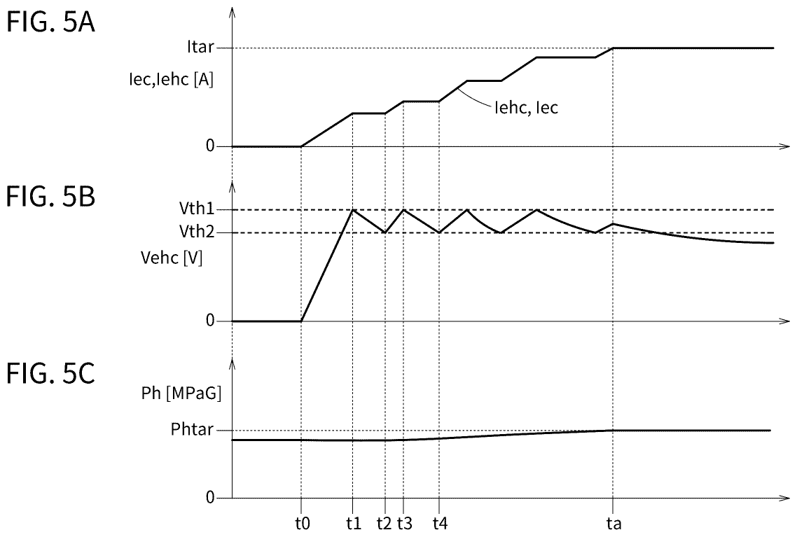

In this instance, an example of the EC & EHC cooperative pressure rising mode process that was described by using the flowchart of FIG. 3 and FIG. 4 will be described hereinafter with reference to the time charts of FIG. 5A, FIG. 5B, and FIG. 5C (sequence at the time of initiation).

Moreover, in the time charts of FIG. 5A, FIG. 5B, and FIG. 5C, it is assumed that the EC pressure rising mode process is completed at time t0 (in FIG. 3, step S3: YES). More specifically, the hydrogen compression stack 18 is brought into a state in which a predetermined pressure value is reached that enables the hydrogen compression stack to operate stably. Further, in the time chart of FIG. 5A, in order to facilitate understanding, the EC target electrical current Iectar and the EHC target electrical current Iehctar are set to the same target electrical current Itar.

FIG. 5A is a time chart showing changes over time in a waveform of the EC electrical current Iec [A] as the cell current of the water electrolysis stack 12 that is detected by the electrical current sensor 91, and a waveform of the EHC electrical current Iehc [A] as the cell current of the hydrogen compression stack 18 that is detected by the electrical current sensor 93. The EC electrical current Iec and the EHC electrical current Iehc are controlled in a manner so as to increase in coordination (in synchronization) and in a stepwise manner (in a state of repeatedly increasing and in a state of maintaining a constant current value). In FIG. 5A, the target electrical current Itar is scaled (is set) on a vertical axis on which the EC electrical current Iec and the EHC electrical current Iehc are shown.

FIG. 5B is a time chart showing changes over time in a waveform of the EHC cell voltage Vehc [V] of the hydrogen compression stack 18 that is detected by the voltage sensor 94. In FIG. 5B, the first voltage threshold value (the membrane protective voltage) Vth1, and the second voltage threshold value (the flooding elimination voltage) Vth2 (Vth2<Vth1) are scaled (are set) on a vertical axis on which the cell voltage Vehc of the hydrogen compression stack 18 is shown.

FIG. 5C is a time chart showing changes over time, as detected by the pressure sensor 60, in a waveform of a supply pressure of hydrogen Ph [MPaG], which is a supply pressure of the hydrogen gas that passes through the first hydrogen supply path 32 and is supplied from the side of the gas/liquid separator 14 to the hydrogen compression stack 18. In FIG. 5C, a target hydrogen supply pressure value Phtar is scaled (is set) on a vertical axis on which the hydrogen supply pressure Ph is shown. After time t0, the EC and EHC cooperative pressure rising mode process corresponding to the process from step S5 and thereafter is started.

At time t0, the control device 28, together with causing the EC electrical current Iec, which is gradually increasing, to be supplied from the electrical power source device 13 to the water electrolysis stack 12, also causes the EHC electrical current Iehc, which gradually increases in coordination with the EC electrical current Iec, to be supplied from the electrical power source device 19 to the hydrogen compression stack 18 (FIG. 5A).

Therefore, as shown in FIG. 5A, from time t0, the EC electrical current Iec and the EHC electrical current Iehc rise at the same gradient G {(G=ΔIec/Δt)=(ΔIehc/Δt)}.

In the case that, at the time of initiation from time t0, flooding is generated at the anode 21a of the hydrogen compression stack 18, then as a result of the increase in the cell resistance value of the hydrogen compression stack 18, as shown in FIG. 5B, the EHC cell voltage Vehc detected by the voltage sensor 94 increases.

At time t1, the EHC cell voltage Vehc increases to the first voltage threshold value (the membrane protective voltage) Vth1. At that time t1, the control device 28 stops the increasing of the EC electrical current Iec and the EHC electrical current Iehc that are gradually increasing in coordination, and starts the control to maintain the EHC electrical current Iehc at the value at the time of suspension (the constant current value) and the FB control of the EC electrical current Iec.

Between time t1 and time t2, in the case that the EHC electrical current Iehc is maintained at the constant current value, then in the hydrogen compression stack 18, since protons move through the electrolyte membrane 21e from the side of the anode 21a to the side of the cathode 21c along with the water, the flooding goes toward being eliminated, and the cell resistance value decreases. In accordance therewith, at time t2, the cell voltage Vehc decreases until reaching the second voltage threshold value (the flooding elimination voltage) Vth2.

At time t2 at which it is determined that the flooding has been eliminated, the control device 28, once again, supplies, from the electrical power source device 13 to the water electrolysis stack 12, the EC electrical current Iec, which gradually increases from the aforementioned electrical current value and supplies, from the electrical power source device 19 to the hydrogen compression stack 18, the EHC electrical current Iehc, which gradually increases from the aforementioned constant electrical current value in coordination with the EC electrical current Iec.

The control device 28, after time t2 and until time ta, causes the EC current Iec from the electrical power source device 13 and the EHC current Iehc from the electrical power source device 19 to increase in a stepwise manner in coordination, in a manner so that the EHC cell voltage Vehc falls between the first voltage threshold value Vth1 and the flooding elimination voltage Vth2.

At time ta, the EHC electrical current Iehc increases until reaching the target electrical current Itar (the EHC target electrical current Iehctar) (step S7 of FIG. 3: YES), and at this time, in order to maintain the pressure of the hydrogen that is supplied from the gas/liquid separator 14 to the hydrogen compression stack 18 at the target hydrogen supply pressure value Phtar of a constant value (refer to FIG. 5C), the control device 28 switches to the FB control of the EHC electrical current Iehc (step S13 of FIG. 4). In the case that the EC electrical current Iec is lower than the EC target electrical current Iectar (step S14 of FIG. 4: NO), the control device 28 causes the EC electrical current Iec to increase (step S15). On the other hand, in the case that the EC electrical current Iec has reached the target electrical current Itar (the EC target electrical current Iectar) (step S14: YES), the determination of the completion of the production of gas is carried out (step S16). If the production of gas has not been completed (step S16: NO), the FB control of the EHC electrical current Iehc in step S13 is continued until the production of gas is completed.

### Second Exemplary Embodiment

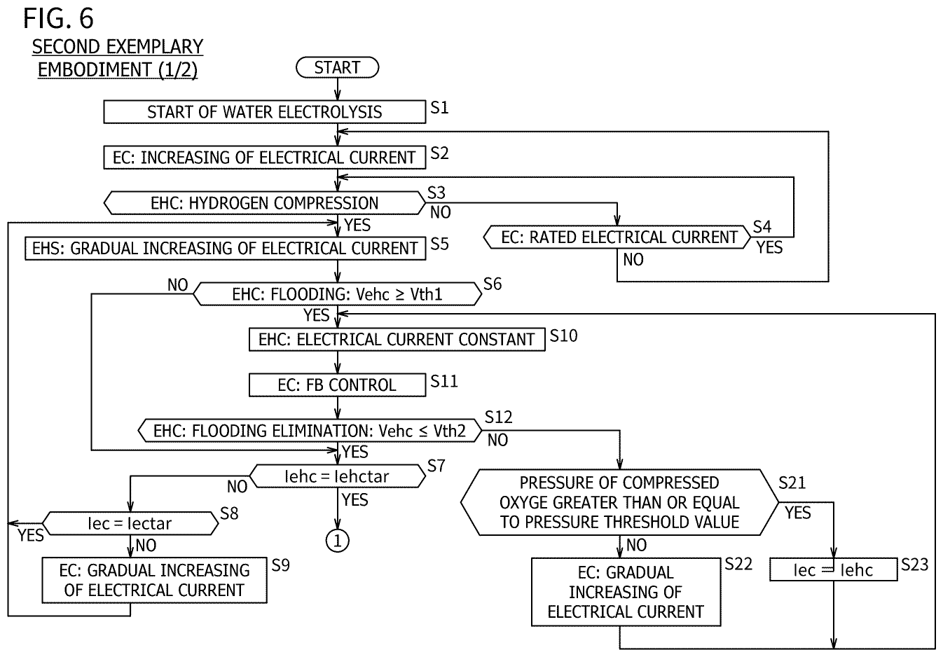

Next, a description will be given with reference to the flowchart of FIG. 6 concerning a second exemplary embodiment of the flooding elimination control of the hydrogen compression stack 18 in the pressure rising mode process of the water electrolysis system 11.

Moreover, in the flowchart of FIG. 6, the same processes as those in the flowchart of FIG. 3 are assigned the same step numbers, and detailed description of such steps will be omitted.

In the above-described flowchart of FIG. 3, in the case that the determination of the elimination of flooding in step S12 is negative (step S12: NO), then in step S10, the control device 28 immediately continues to execute the process of stabilizing the EHC electrical current Iehc.

In contrast thereto, in the flowchart of FIG. 6, in the case that the determination of the elimination of flooding in step S12 is negative (step S12: NO), then in step S21 to step S23, the control device 28 executes an oxygen pressure rising confirmation and countermeasure process and an electrical current equalization process.

More specifically, in step S21, the control device 28 determines whether or not the pressure of the oxygen that is compressed on the side of the anode 15a (the oxygen supply path 43) of the water electrolysis stack 12 as detected by the pressure sensor 61 is greater than or equal to a pressure threshold value.

In the case that the pressure of the oxygen that is compressed is less than the pressure threshold value (step S21: NO), then in step S22, in order to cause the pressure on the side of the anode 15a to increase in a manner so that cross leakage of the hydrogen on the side of the cathode 15c to the side of the anode 15a does not occur, the control device 28 gradually increases the EC electrical current Iec that is supplied to the water electrolysis stack 12.

In this case, the control device 28 repeats the processes of step S22→step S10→step S11→step S12: NO-step S21: NO, and at the time when the determination of step S21 has become positive (step S21: YES), advances the process to step S23.

In step S23, the control device 28 makes the values of the EC electrical current Iec and the EHC current Iehc equal, whereupon the process advances to step S10.

Next, until the flooding has been eliminated (step S12: YES), the control device 28 repeats the processes of step S12: NO→step S21: YES→step S23→step S10-step S11→step S12.

After the flooding has been eliminated in step S12 by repeating this process (step S12: YES), then from step S7: NO and thereafter, the control device 28 executes the EC and EHC cooperative pressure rising mode process. During the execution of the EC and EHC cooperative pressure rising mode process, at the time when the EHC electrical current Iehc has reached the target electrical current Iehctar, and the determination in step S7 has become positive, the control device 28 advances the process to step S13 (FIG. 4). Next, in the same manner as in the first exemplary embodiment, the control device 28 completes the production of gas in the EC and EHC cooperative pressure rising mode process from step S13 and thereafter (step S16: YES). In this manner, in the second exemplary embodiment, at the time when the flooding of the hydrogen compression stack 18 is eliminated, priority is placed on the control that causes the pressure of the oxygen that is compressed by the water electrolysis stack 12 to rise to a pressure at which cross leakage of hydrogen is reduced (step S21: NO→step S22).

### Third Exemplary Embodiment

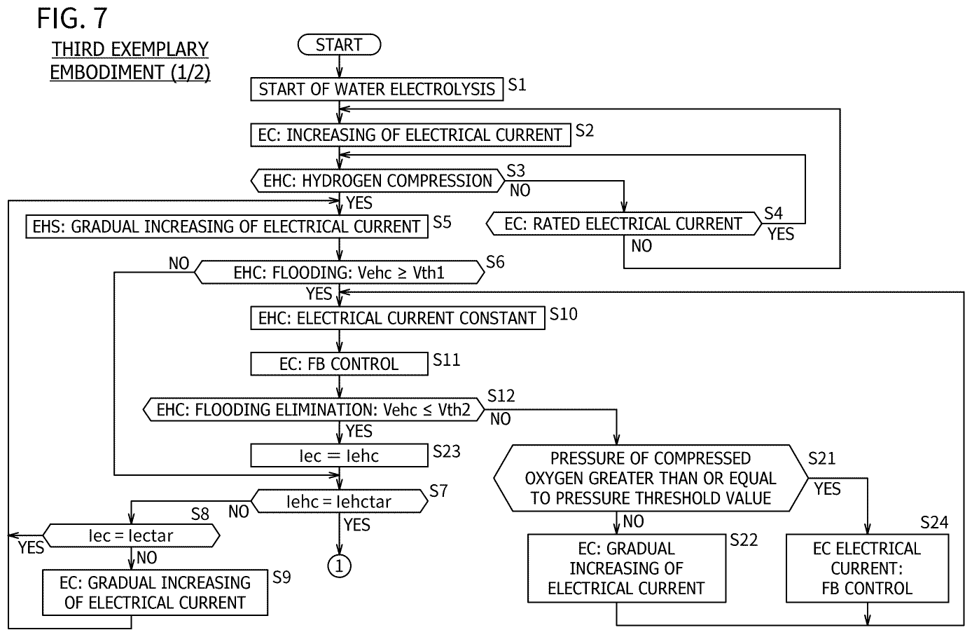

Next, a description will be given with reference to the flowchart of FIG. 7 concerning a third exemplary embodiment of the flooding elimination control of the hydrogen compression stack 18 in the pressure accumulation mode process of the water electrolysis system 11.

Moreover, in the flowchart of FIG. 7, the same processes as those in the flowchart of FIG. 3 and FIG. 6 are assigned the same step numbers, and detailed description of such steps will be omitted.

In the above-described flowchart of FIG. 6, in the case that the determination, at step S21, of whether or not the oxygen that has been compressed is greater than or equal to the pressure threshold value has become positive (step S21: YES), then the control device 28 executes an equalization process so that the EC electrical current Iec and the EHC electrical current Iehc become the same value.

In contrast thereto, in the flowchart of FIG. 7, in the case that the determination, at step S21, of whether or not the oxygen that has been compressed is greater than or equal to the pressure threshold value has become positive (step S21: YES), then in step S24, the control device 28 subjects the EC electrical current Iec to the FB control.

Thereafter, in the determination of step S12, at the time when the flooding has been eliminated (step S12: YES), then in step S23, the control device 28 executes the equalization process to make the value of the EHC electrical current Iehc and the value of the EC electrical current Iec the same value.

After the process of step S23, the control device 28, from step S7: NO and thereafter, executes the EC and EHC cooperative pressure rising mode process. During the execution of the EC and EHC cooperative pressure rising mode process, at the time when the EHC electrical current Iehc has reached the target electrical current Iehctar, and the determination in step S7 has become positive, the process advances to step S13 (FIG. 4). Next, in the same manner as in the first exemplary embodiment and the second exemplary embodiment, the control device 28 completes the production of gas in the EC and EHC cooperative boosting mode process from step S13 and thereafter (step S16: YES).

In this manner, even in the third exemplary embodiment, in the same manner as in the second exemplary embodiment, the control device 28, at the time when the flooding of the hydrogen compression stack 18 is eliminated, prioritizes the control that causes the pressure of the oxygen that is compressed by the water electrolysis stack 12 to rise to a pressure at which cross leakage of hydrogen is reduced (step S21: NO→step S22).

### Supplementary Notes

In relation to the above-described disclosure, the following supplementary notes are further disclosed.

### Supplementary Note 1

The water electrolysis system (11) is a water electrolysis system comprising the water electrolysis stack (12) including the water electrolysis membrane electrode assembly (15m) in which the electrolyte membrane (15e) is sandwiched between the anode (15a) and the cathode (15c), the water electrolysis stack being configured to generate the hydrogen gas and the oxygen gas from the water that is supplied thereto, the water electrolysis electrical power source device (13) that serves to supply the water electrolysis electrical current (Iec) between the anode and the cathode of the water electrolysis membrane electrode assembly (15m), the hydrogen compression stack (18) including the hydrogen compression membrane electrode assembly (21m) in which the electrolyte membrane (21e) is sandwiched between the anode (21a) and the cathode (21c), the hydrogen compression stack being configured to compress the hydrogen gas that is generated by the water electrolysis stack, the hydrogen compression electrical power source device (19) that serves to supply the hydrogen compression electrical current (Iehc) between the anode and the cathode of the hydrogen compression membrane electrode assembly, and the control device (28) that controls the water electrolysis electrical power source device and the hydrogen compression electrical power source device, wherein the control device, at a time when the water electrolysis system is initiated, controls the water electrolysis electrical power source device and the hydrogen compression electrical power source device in a manner so that the water electrolysis electrical current and the hydrogen compression electrical current gradually increase, and while the water electrolysis electrical current and the hydrogen compression electrical current are gradually increasing, detects whether or not flooding is occurring in the hydrogen compression stack, and at a time when it is detected that flooding is occurring, carries out a control to cause the increasing of the water electrolysis electrical current and the hydrogen compression electrical current to be suspended, and to maintain the water electrolysis electrical current and the hydrogen compression electrical current at a constant electrical current value.

In accordance with such a configuration, at a time when the water electrolysis system is initiated, the control device controls the water electrolysis electrical power source device and the hydrogen compression electrical power source device in a manner so that the water electrolysis electrical current and the hydrogen compression electrical current gradually increase.

During the gradual increasing, it is detected whether or not flooding has occurred in the hydrogen compression stack, and at a time when it is detected that flooding is occurring, until the flooding is eliminated, a flooding elimination control is carried out in which the increase in the water electrolysis electrical current and the hydrogen compression electrical current is temporarily suspended, and the water electrolysis electrical current and the hydrogen compression electrical current are maintained at a constant current value.

In accordance with this feature, even if flooding occurs in the hydrogen compression stack at the time when the water electrolysis system is initiated, the flooding can be eliminated without stopping the operation of the water electrolysis system, and the generation of the hydrogen gas and the oxygen gas can be continued. In accordance therewith, it is possible to prevent beforehand malfunctioning of the hydrogen compression stack.

### Supplementary Note 2

In the water electrolysis system according to Supplementary Note 1, the control device may carry out the detection of whether or not flooding is occurring in the hydrogen compression stack, in accordance with whether the cell voltage (Vehc) of the hydrogen compression stack has increased to the first voltage threshold value (Vth1).

The control device, even in the case that flooding occurs in the hydrogen compression stack and an interelectrode area that contributes to compression is reduced, controls the hydrogen gas in a manner so that the target compression value is reached. In order for the hydrogen gas to reach the target compression value, the hydrogen compression current must be increased. As a result, the interelectrode voltage in the hydrogen compression stack increases. Therefore, by monitoring whether the interelectrode voltage of the hydrogen compression stack has reached the first voltage threshold value, the occurrence of flooding can be detected with high accuracy.

### Supplementary Note 3

In the water electrolysis system according to Supplementary Note 1, at the time when the control device detects that the flooding has been eliminated during the control to cause the increase in the water electrolysis electrical current and the hydrogen compression electrical current to be suspended and maintained at the constant electrical current value, the control device may control the water electrolysis electrical power source device and the hydrogen compression electrical power source device in a manner so that the water electrolysis electrical current and the hydrogen compression electrical current increase gradually in a stepwise manner from the electrical currents that are maintained at the constant current value.

In accordance with such a configuration, at the time when the flooding is detected at the time of initiation, the water electrolysis electrical power source device and the hydrogen compression electrical power source device are controlled in a manner so that the water electrolysis electrical current and the hydrogen compression electrical current gradually increase in coordination. In accordance with this feature, while flooding of the hydrogen compression stack at the time of being initiated is prevented, the water electrolysis electrical current and the hydrogen compression electrical current can be increased to the target electrical current value.

### Supplementary Note 4

In the water electrolysis system according to Supplementary Note 3, the control device may carry out the detection of whether or not the flooding of the hydrogen compression stack has been eliminated, in accordance with whether or not the interelectrode voltage (Vehc) of the hydrogen compression stack has decreased to the second voltage threshold value (Vth2).

While the flooding in the hydrogen compression stack is being eliminated, the membrane resistance of the electrolyte membrane decreases. During such a flooding elimination control, the hydrogen compression electrical current is maintained at a constant current value, and therefore, the interelectrode voltage decreases. Therefore, by monitoring whether or not the interelectrode voltage has decreased to the second voltage threshold value that is lower than the first voltage threshold value, it is possible to accurately detect whether the flooding of the hydrogen compression stack has been eliminated.

### Supplementary Note 5

In the water electrolysis system according to Supplementary Note 3, the control device, at the time when the water electrolysis electrical current and the hydrogen compression electrical current are being gradually increased in a stepwise manner, and at the time when the water electrolysis electrical current and the hydrogen compression electrical current have reached the target electrical current value, the water electrolysis electrical current and the hydrogen compression electrical current may be controlled in a manner so that the pressure of the hydrogen gas that is supplied from the water electrolysis stack to the hydrogen compression stack becomes a constant value.

In accordance with such a configuration, while the flooding at the time of initiation is eliminated, the water electrolysis stack and the hydrogen compression stack can be controlled until reaching the target electrical current value, and after having been controlled to reach the target electrical current value, the water electrolysis electrical current and the hydrogen compression electrical current may be controlled in coordination in a manner so that the pressure of the hydrogen that is supplied from the water electrolysis stack to the hydrogen compression stack is constant, and therefore, from the time of being initiated, the water electrolysis system can be made to operate stably in a continuous manner.

### Supplementary Note 6

In the water electrolysis system according to Supplementary Note 1, the gas/liquid separator (14) may be disposed between the water electrolysis stack and the hydrogen compression stack, and the hydrogen circulation pump (34) may be disposed between the gas/liquid separator and the hydrogen compression stack, and the control device, at the time of being initiated, by driving the hydrogen circulation pump, may cause the hydrogen gas to flow to the anode of the hydrogen compression stack, and may thereby eliminate the flooding of the anode.

In accordance with such a configuration, the flooding, which has been caused at the time when the operation of the hydrogen compression stack is suspended, can be reliably eliminated at the time of being initiated.

### Supplementary Note 7

The method of controlling the water electrolysis system, comprising the water electrolysis stack including the water electrolysis membrane electrode assembly in which the electrolyte membrane is sandwiched between the anode and the cathode, the water electrolysis stack being configured to generate the hydrogen gas and the oxygen gas from the water that is supplied thereto, the water electrolysis electrical power source device that serves to supply the water electrolysis electrical current between the anode and the cathode of the water electrolysis membrane electrode assembly, the hydrogen compression stack including the hydrogen compression membrane electrode assembly in which the electrolyte membrane is sandwiched between the anode and the cathode, the hydrogen compression stack being configured to compress the hydrogen gas that is generated by the water electrolysis stack, and the hydrogen compression electrical power source device that serves to supply the hydrogen compression electrical current between the anode and the cathode of the hydrogen compression membrane electrode assembly, and the control device that serves to control the water electrolysis electrical power source device and the hydrogen compression electrical power source device, the method of controlling the water electrolysis system including the step of controlling, at the time when the water electrolysis system is initiated, the water electrolysis electrical power source device and the hydrogen compression electrical power source device in a manner so that the water electrolysis electrical current and the hydrogen compression electrical current gradually increase, the step of detecting, at the time when the water electrolysis electrical current and the hydrogen compression electrical current are gradually increasing, whether or not the flooding is occurring in the hydrogen compression stack, and at the time when it is detected that the flooding is occurring, the step of causing the increasing of the water electrolysis electrical current and the hydrogen compression electrical current to be suspended, and maintaining the water electrolysis electrical current and the hydrogen compression electrical current at the constant electrical current value.

In accordance with such a configuration, even if flooding occurs in the hydrogen compression stack at the time when the water electrolysis system is initiated, the flooding can be eliminated without suspending the operation of the water electrolysis system, and the generation of the hydrogen gas and the oxygen gas can be continued.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the 10 operations and the order of each of the processes are shown merely as examples, and the present invention is not necessarily limited to these examples. The same applies also in the case that numerical values or mathematical expressions are used in the description of the aforementioned embodiments.

1. A water electrolysis system, comprising:
a water electrolysis stack comprising a water electrolysis membrane electrode assembly in which an electrolyte membrane is sandwiched between an anode and a cathode, and configured to generate hydrogen gas and oxygen gas from water that is supplied thereto;
a water electrolysis electrical power source device configured to supply a water electrolysis electrical current between the anode and the cathode of the water electrolysis membrane electrode assembly;
a hydrogen compression stack comprising a hydrogen compression membrane electrode assembly in which an electrolyte membrane is sandwiched between an anode and a cathode, and configured to compress a pressure of the hydrogen gas that is generated by the water electrolysis stack;
a hydrogen compression electrical power source device configured to supply a hydrogen compression electrical current between the anode and the cathode of the hydrogen compression membrane electrode assembly; and
one or more processors that execute computer-executable instructions stored in a memory,
wherein the one or more processors execute the computer-executable instructions to cause the water electrolysis system to:
at a time when the water electrolysis system is initiated, control the water electrolysis electrical power source device and the hydrogen compression electrical power source device in a manner so that the water electrolysis electrical current and the hydrogen compression electrical current gradually increase; and
while the water electrolysis electrical current and the hydrogen compression electrical current are gradually increasing, detect whether or not flooding is occurring in the hydrogen compression stack, and at a time when it is detected that flooding is occurring, carry out a control to cause the increasing of the water electrolysis electrical current and the hydrogen compression electrical current to be suspended, and to maintain the water electrolysis electrical current and the hydrogen compression electrical current at a constant electrical current value.

2. The water electrolysis system according to claim 1, wherein the one or more processors cause the water electrolysis system to carry out detecting of whether or not flooding is occurring in the hydrogen compression stack, in accordance with whether a cell voltage of the hydrogen compression stack has increased to a first voltage threshold value.

3. The water electrolysis system according to claim 1, wherein at a time when it is detected that the flooding has been eliminated during the control to cause the increase in the water electrolysis electrical current and the hydrogen compression electrical current to be suspended and cause the water electrolysis electrical current and the hydrogen compression electrical current to be maintained at the constant electrical current value, the one or more processors cause the water electrolysis system to control the water electrolysis electrical power source device and the hydrogen compression electrical power source device in a manner so that the water electrolysis electrical current and the hydrogen compression electrical current increase gradually in a stepwise manner from the electrical currents that are maintained at the constant electrical current value.

4. The water electrolysis system according to claim 3, wherein the one or more processors cause the water electrolysis system to carry out detection of whether or not the flooding of the hydrogen compression stack has been eliminated, in accordance with whether or not an interelectrode voltage of the hydrogen compression stack has decreased to a second voltage threshold value.

5. The water electrolysis system according to claim 3, wherein at a time when the water electrolysis electrical current and the hydrogen compression electrical current are being gradually increased in the stepwise manner, and at a time when the water electrolysis electrical current and the hydrogen compression electrical current has reached a target electrical current value, the one or more processors cause the water electrolysis system to control the water electrolysis electrical current and the hydrogen compression electrical current in a manner so that a pressure of the hydrogen gas that is supplied from the water electrolysis stack to the hydrogen compression stack becomes a constant value.

6. The water electrolysis system according to claim 1, wherein:
a gas/liquid separator is disposed between the water electrolysis stack and the hydrogen compression stack, and a hydrogen circulation pump is disposed between the gas/liquid separator and the hydrogen compression stack; and
at a time of being initiated, the one or more processors cause the water electrolysis system to drive the hydrogen circulation pump to cause the hydrogen gas to flow to the anode of the hydrogen compression stack, and thereby eliminate the flooding in the anode.

7. A method of controlling a water electrolysis system, comprising a water electrolysis stack comprising a water electrolysis membrane electrode assembly in which an electrolyte membrane is sandwiched between an anode and a cathode, and configured to generate hydrogen gas and oxygen gas from water that is supplied thereto, a water electrolysis electrical power source device configured to supply a water electrolysis electrical current between the anode and the cathode of the water electrolysis membrane electrode assembly, a hydrogen compression stack comprising a hydrogen compression membrane electrode assembly in which an electrolyte membrane is sandwiched between an anode and a cathode, and configured to compress a pressure of the hydrogen gas that is generated by the water electrolysis stack, and a hydrogen compression electrical power source device configured to supply a hydrogen compression electrical current between the anode and the cathode of the hydrogen compression membrane electrode assembly, and a control device configured to control the water electrolysis electrical power source device and the hydrogen compression electrical power source device, the method of controlling the water electrolysis system comprising:
controlling, at a time when the water electrolysis system is initiated, the water electrolysis electrical power source device and the hydrogen compression electrical power source device in a manner so that the water electrolysis electrical current and the hydrogen compression electrical current gradually increase;
detecting, at a time when it is detected that the water electrolysis electrical current and the hydrogen compression electrical current are gradually increasing, whether or not flooding is occurring in the hydrogen compression stack; and
at a time when it is detected that flooding is occurring, causing increasing of the water electrolysis electrical current and the hydrogen compression electrical current to be suspended, and maintaining the water electrolysis electrical current and the hydrogen compression electrical current at a constant electrical current value.
